(19) United States
(12) Patent Application Publication
(10) Pub. No.: US 2009/0052551 A1
(43) Pub. Date: Feb. 26, 2009

(54) METHOD AND APPARATUS FOR CODING MOVING IMAGE AND IMAGING SYSTEM

(76) Inventor: Shinji Kitamura, Kyoto (JP)

Correspondence Address: MCDERMOTT WILL & EMERY LLP, 600 13TH STREET, NW, WASHINGTON, DC, 20005-3096, US

(21) Appl. No.: 12/193,334

(22) Filed: Aug. 18, 2008

(30) Foreign Application Priority Data
Aug. 23, 2007 (JP) 2007-217192
Mar. 19, 2008 (JP) 2008-072236

(51) Int. Cl. H04N 7/24

(52) U.S. Cl. 375/240.26; 375/E07.02

(57) ABSTRACT

A moving image signal is coded so that a coded stream is generated. Coded pictures are periodically eliminated from the coded moving image signal so that another coded stream associated with another moving image signal having a frame rate different from the coded moving image signal is generated.

### BACKGROUND OF THE INVENTION

The present invention relates to a technique for coding moving image signals into coded streams.

In recent years, highly-efficient coding techniques for processing moving images such as MPEG-4, H.264 (MPEG-4 AVC) including MPEG-2 have been intensively studied to be applied to various fields such as computers, communication, consumer AV equipment and broadcasting. In particular, to provide consumer cameras such as video or digital still cameras at low cost, it is very important to implement a moving image coding technique for processing an enormous amount of data in a small size with low power consumption. Thus, studies for reducing size and power consumption of this technique are also intensively carried out. For transmission camera equipment such as a network camera with which coded streams (i.e., compressed data of moving images) are transmitted via a communication line such as the Internet, a plurality of moving image signals with different resolutions and frame rates need to be coded for transmission and, therefore, increase in speed, as well as reduction in size and power consumption, of the technique is also strongly needed.

To meet such demands, moving image coding apparatus for coding a plurality of moving image signals in a time-division manner is employed. The moving image coding apparatus includes a plurality of channels to which a plurality of moving image signals as a target of coding are allocated. These moving image signals are coded for every channel so that a plurality of coded streams obtained by coding are controlled for every channel.

Now, a conventional moving image coding method is described with reference to FIG. 11. In FIG. 11, three moving image signals with resolutions of “4VGA (1280×960)”, “VGA (640×480)” and “QVGA (320×240)” are respectively allocated to three channels (i.e., channel 0, channel 1 and channel 2) and are coded in a time-division manner.

Pictures I0(0), P1(0), . . . and P3(0) are pictures of the moving image signal with a resolution of “4VGA”. Pictures I0(1), P1(1), . . . and P3(1) are pictures of the moving image signal with a resolution of “VGA”. Pictures I0(2), P1(2), . . . and P3(2) are pictures of the moving image signal with a resolution of “QVGA”.

First, the first pictures I0(0), I0(1) and I0(2) of the respective three moving image signals are sequentially subjected to intra-frame prediction coding (intra-coding) for a given time (which is 1/30 [s] in this case), thereby generating coded pictures D0(0), D0(1) and D0(2). Then, the coded pictures D0(0), D0(1) and D0(2) are output as a coded stream STR0 of a channel 0, a coded stream STR1 of a channel 1 and a coded stream STR2 of a channel 2, respectively. In addition, the pictures I0(0), I0(1) and I0(2) are reconstructed from the coded pictures D0(0), D0(1) and D0(2) and are stored, as reference pictures, in a reference memory of the moving image coding apparatus. That is, three reference pictures associated with three moving image signals are stored in the reference memory.

Next, the second pictures P1(0), P1(1) and P1(2) of the respective three moving image signals are subjected to inter-frame prediction coding (inter-coding) in a time-division manner, using the reference pictures (i.e., the pictures I0(0), I0(1) and I0(2)) associated with the respective pictures P1(0), P1(1) and P1(2), thereby generating coded pictures D1(0), D1(1) and D1(2). The coded pictures D1(0), D1(1) and D1(2) are output as a coded stream STR0 of the channel 0, a coded stream STR1 of the channel 1 and a coded stream STR2 of the channel 2, respectively. Pictures P1(0), P1(1) and P1(2) are reconstructed from the respective coded pictures D1(0), D1(1) and D1(2) and the reference pictures I0(0), I0(1) and I0(2). The reference pictures (i.e., the pictures I0(0), I0(1) and I0(2)) stored in the reference memory are rewritten as the reconstructed pictures P1(0), P1(1) and P1(2).

In this manner, three moving image signals are coded in a time-division manner, thereby outputting three coded streams associated with three moving image signals. Every time pictures are coded, reference pictures associated with these pictures are rewritten in order to allow inter-coding of each of the second and subsequent pictures with its immediately preceding picture used as a reference picture.

However, the foregoing moving image coding apparatus has limitations in its processing performance. Therefore, to perform coding which exceeds the maximum processing performance, such as the maximum number of channels (i.e., the number of processable moving image signals) and the maximum processing speed (i.e., the amount of data coded per unit time), of the moving image coding apparatus, it was necessary to use another moving image coding apparatus having higher performance than this apparatus or to provide a plurality of sets of moving image coding apparatus together. As the number of moving image signals as a target of coding (i.e., the number of channels) increases, the number of reference pictures increases, resulting in the necessity for increasing the capacity of a reference memory for storing the reference pictures. In this way, conventional apparatus involves the necessity for increasing the maximum number of channels in order to code a large number of moving image signals and the necessity for increasing the maximum processing speed in order to code a plurality of moving image signals with high resolutions and high frame rates. Accordingly, enhancement of function and performance of moving image coding apparatus disadvantageously increases power consumption and circuit scale of the moving image coding apparatus, thus making it difficult to reduce the size and power consumption of the apparatus.

### SUMMARY OF THE INVENTION

It is therefore an object of the present invention to generate coded streams associated with a larger number of moving image signals, without increase in power consumption and circuit scale of moving image coding apparatus.

In an aspect of the present invention, a method for coding a moving image signal including a plurality of pictures arranged in chronological order includes the steps of: (a) coding the moving image signal into a coded stream; and (b) periodically eliminating at least one coded picture from the moving image signal coded at step (a), thereby generating another coded stream associated with another moving image signal having a frame rate different from that of the coded moving image signal.

With this moving image coding method, a plurality of coded streams associated with a plurality of moving image signals are generated from one moving image signal without individually coding the moving image signals. Accordingly, coded streams associated with a larger number of moving image signals than that with conventional methods are generated without increase in power consumption and circuit scale of moving image coding apparatus.

Preferably, in step (a), a first moving image signal having a highest frame rate among m (where m is an integer of at least two) moving image signals having an identical resolution and different frame rates is coded into a first coded stream associated with the first moving image signal, and in step (b), at least one coded picture is eliminated from the first moving image signal coded at step (a) based on the frame rates of (m−1) second moving image signals obtained by removing the first moving image signal from the m moving image signals, thereby generating (m−1) second coded streams associated with the (m−1) second moving image signals.

With this moving image coding method, m coded streams are generated only by coding a moving image signal with the highest frame rate.

The method preferably further includes the steps of: (c1) determining whether or not the number m of moving image signals as a target of coding exceeds a predetermined maximum number of moving image signals; and (d) coding the m moving image signals in a time-division manner into m coded moving image signals as m coded streams when it is determined at step (c1) that the number m of the moving image signals does not exceed the maximum number. Steps (a) and (b) are preferably performed when it is determined at step (c1) that the number m of the moving image signals exceeds the maximum number.

With this moving image coding method, when the number of moving image signals as a target of coding exceeds the maximum number of moving image signals which can be processed in a time-division manner by moving image coding apparatus, for example, a plurality of coded streams are generated based on one moving image signal. Thus, a large number of moving image signals are processed, as compared to conventional methods.

The method preferably further includes the steps of: (c2) determining whether or not a necessary processing speed necessary for coding the m moving image signals in a time-division manner exceeds a predetermined maximum processing speed; and (d) coding the m moving image signals in a time-division manner into m coded moving image signals as m coded streams when it is determined at step (c2) that the necessary processing speed does not exceed the maximum processing speed. Steps (a) and (b) are preferably performed when it is determined at step (c2) that the necessary processing speed exceeds the maximum processing speed.

With this method, when the processing speed necessary for processing moving image signals as a target of coding in a time-division manner exceeds the maximum processing speed of the moving image coding apparatus, for example, a plurality of coded streams are generated based on one moving image signal. Thus, a large number of moving image signals are processed, as compared to conventional methods.

In another aspect of the present invention, a moving image coding apparatus for coding a moving image signal including a plurality of pictures arranged in chronological order includes: a coding section for coding the moving image signal into a coded stream; and a stream generating section for periodically eliminating at least one coded picture from the moving image signal coded by the coding section, thereby generating another coded stream associated with another moving image signal having a frame rate different from that of the coded moving image signal.

In this moving image coding apparatus, a plurality of coded streams associated with a plurality of moving image signals are generated from one moving image signal without individually coding the moving image signals. Accordingly, coded streams associated with a larger number of moving image signals than in conventional apparatus are generated without increase in power consumption and circuit scale of the moving image coding apparatus. As a result, reduction in size and power consumption of moving image coding apparatus is achieved.

### BRIEF DESCRIPTION OF THE DRAWINGS

FIG. 1 is a block diagram illustrating a configuration of moving image coding apparatus according to a first embodiment of the present invention.

FIG. 2 is a flowchart for explaining operation of the moving image coding apparatus illustrated in FIG. 1.

FIG. 3 is a flowchart for explaining multi-stream generation processing by the moving image coding apparatus illustrated in FIG. 1.

FIG. 4 is a diagram for explaining moving image signals coded by multi-stream generation processing.

FIG. 5 is diagram for explaining coded stream output by multi-stream generation processing.

FIG. 6 is a diagram for explaining a modified example of multi-stream generation processing.

FIG. 7A is a flowchart for explaining a first modified example of the first embodiment.

FIG. 7B is a flowchart for explaining a second modified example of the first embodiment

FIG. 8 is a block diagram illustrating a configuration of an imaging system according to a second embodiment of the present invention.

FIG. 9 is a flowchart for explaining moving image coding processing with the imaging system illustrated in FIG. 8.

FIG. 10 is a block diagram for explaining an example of application of moving image coding apparatus according to an embodiment to an imaging system.

FIG. 11 is a diagram for explaining conventional coding of moving image signals.

### DETAILED DESCRIPTION OF THE INVENTION

Hereinafter, embodiments of the present invention will be described with reference to the drawings.

### Embodiment 1

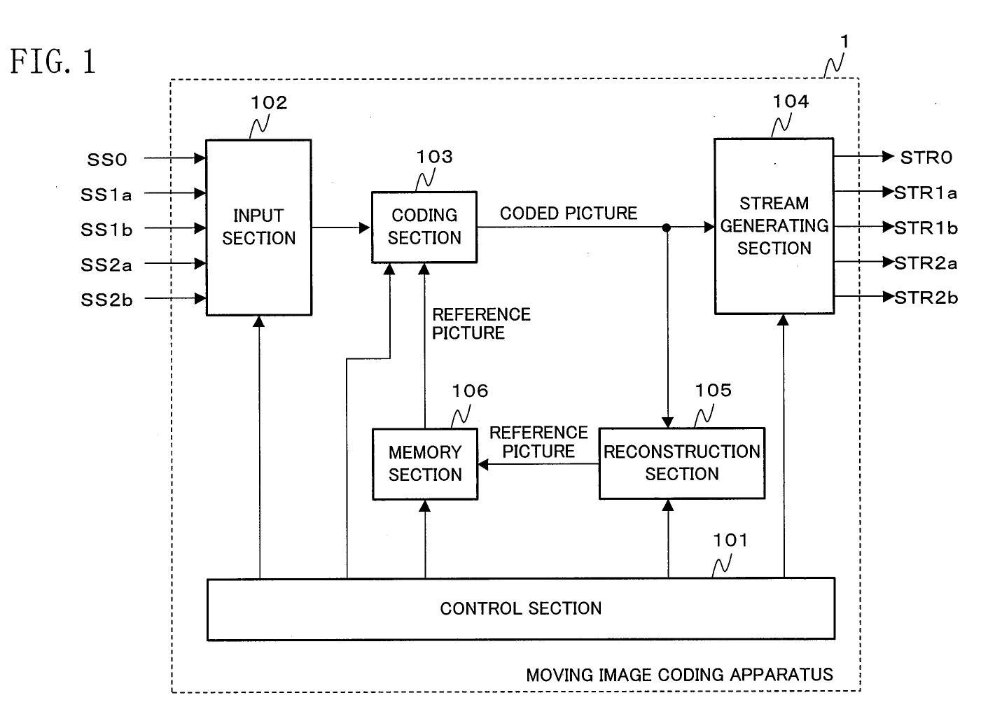

FIG. 1 illustrates a configuration of moving image coding apparatus according to a first embodiment of the present invention. In the moving image coding apparatus 1, channels are respectively allocated to a plurality of moving image signals (which are five moving image signals SS0 to SS2b in this embodiment) and the moving image signals are coded in a time-division manner on a picture-by-picture basis, thereby generating a plurality of coded streams (which are five coded streams STR0 to STR2b in this embodiment) associated with the moving image signals. The moving image coding apparatus 1 includes: a control section 101; an input section 102; a coding section 103; a stream generating section 104; a reconstruction section 105; and a memory section 106.

The control section 101 controls the input section 102, the coding section 103, the stream generating section 104, the reconstruction section 105 and the memory section 106. The control section 101 determines settings of coding, allocates channels to the moving image signals SS0 to SS2b as a target of coding, specifies a channel (i.e., specifies a moving image signal to be coded) and sets the modes of the stream generating section 104 and the reconstruction section 105, for example.

The input section 102 receives the moving image signals SS0 to SS2b as a target of coding and supplies, to the coding section 103, a picture of one of the moving image signals (i.e., a moving image signal to be coded) corresponding to a channel specified by the control section 101.

The coding section 103 codes pictures supplied from the input section 102. If a picture from the input section 102 is an “I-picture”, the coding section 103 performs intra-frame prediction coding (intra-coding) on this picture. On the other hand, if a picture from the input section 102 is a “P-picture”, the coding section 103 reads a reference picture associated with this picture from the memory section 106, and performs inter-frame prediction coding (inter-coding) on the picture from the input section 102 using the read-out reference picture.

The stream generating section 104 has a normal mode and a multi-stream generation mode. When being placed in the normal mode, the stream generating section 104 outputs a picture coded by the coding section 103 as a coded stream associated with this picture. When being placed in the multi-stream generation mode, the stream generating section 104 reduces the number of (i.e., eliminates one or more) coded pictures in order to generate another coded stream.

The reconstruction section 105 has a normal mode and a multi-stream generation mode. When being placed in the normal mode, the reconstruction section 105 reconstructs an original picture (i.e., a picture before coding) from the picture coded by the coding section 103, and writes the reconstructed picture in the memory section 106 as a reference picture. When being set in the multi-stream generation mode, the reconstruction section 105 reconstructs a reference picture only from the coded pictures which are not eliminated by the stream generating section 104.

The memory section 106 stores reference pictures associated with moving image signals.

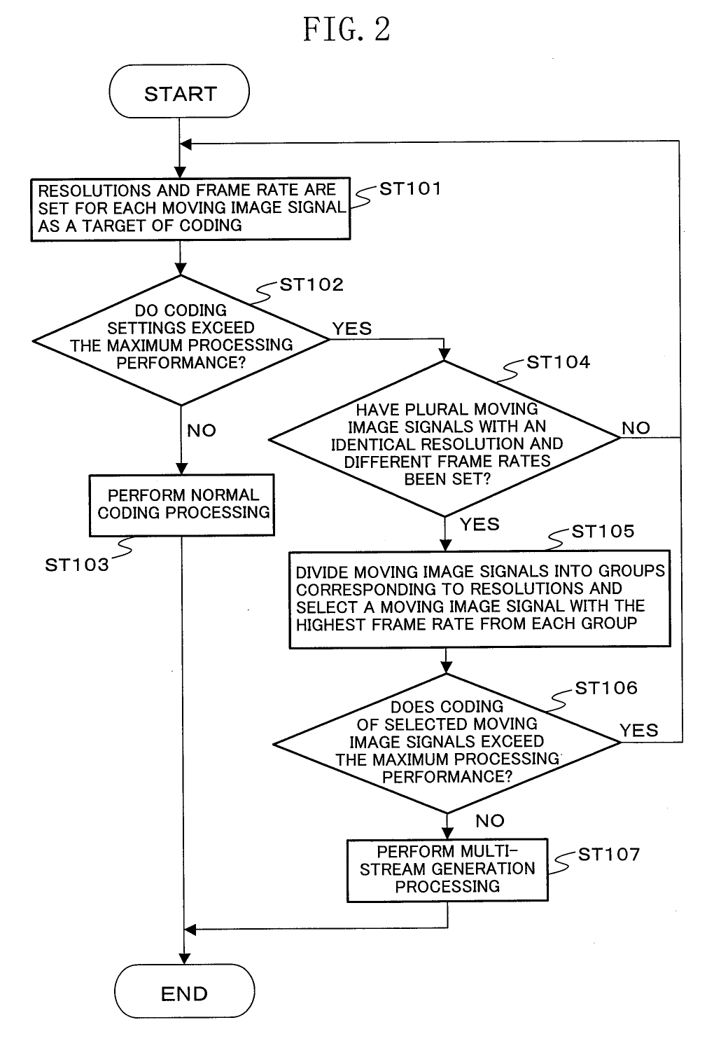

Now, operation of the moving image coding apparatus 1 illustrated in FIG. 1 is described with reference to FIG. 2. In the following description, the maximum number of channels (i.e., the number of processable moving image signals) of the moving image coding apparatus 1 is “5” and the maximum processing speed (i.e., the amount of data coded per unit time) of the moving image coding apparatus 1 is “49,152,000 (=1,280×1,280×30) [pixels/s]”. In other words, the moving image coding apparatus 1 is able to process five moving image signals and 30 frames of pictures each made of horizontal 1,280 [pixels]×vertical 1,280 [pixels] are coded in a second.

### [Step ST101]

First, the resolutions and frame rates of the moving image signals SS0 to SS2b as a target of coding are set. An example of the settings is as follows:

### <Example of Setting for Coding>

| | |
|---|---|
| Moving image signal SS0 | resolution: 4 VGA (1,280 × 960 [pixels]) |
| | frame rate: 30 [f/s] |
| Moving image signal SS1a | resolution: VGA (640 × 480 [pixels]) |
| | frame rate: 30 [f/s] |
| Moving image signal SS1b | resolution: VGA (640 × 480 [pixels]) |
| | frame rate: 15 [f/s] |
| Moving image signal SS2a | resolution: QVGA (320 × 240 [pixels]) |
| | frame rate: 30 [f/s] |
| Moving image signal SS2b | resolution: QVGA (320 × 240 [pixels]) |
| | frame rate: 15 [f/s] |

The control section 101 receives information on these coding settings.

### [Step ST102]

Next, the control section 101 determines whether or not the coding settings exceed the maximum processing performance (such as the maximum number of channels and the maximum processing speed) of the moving image coding apparatus 1. If the coding settings do not exceed the maximum processing performance, the process proceeds to step ST103. Otherwise, the process proceeds to step ST104. Specifically, the control section 101 determines whether or not the number of moving image signals indicated in the coding settings exceeds the maximum channel number of the moving image coding apparatus 1. The control section 101 also determines whether or not the processing speed necessary for coding the moving image signals indicated in the coding settings in a time-division manner exceeds the maximum processing speed of the moving image coding apparatus 1. If the coding settings exceed at least one of the maximum channel number and the maximum processing speed, the process proceeds to step ST104.

For example, in the case where the resolutions of all the five moving image signals SS0 to SS2b are “VGA (640×480 [pixels]) and the frame rates thereof are “30 [f/s]”, the processing speed (i.e., the amount of data to be coded per unit time) necessary for time-division coding processing of the moving image signals SS0 to SS2b is 46,080,000 (=640×480×30×5) [pixels/s] and does not exceed the maximum processing speed (49,152,000 [pixels/s]).

On the other hand, in the above example of coding settings, the processing speeds necessary for the respective moving image signals SS0 to SS2b are:

Moving image signal SS0: 36,864,000 (1,280×960×30) [pixels/s]

Moving image signal SS1a: 9,216,000 (640×480×30) [pixels/s]

Moving image signal SS1b: 4,608,000 (640×480×15) [pixels/s]

Moving image signal SS2a: 2,304,000 (320×240×30) [pixels/s]

Moving image signal SS2b: 1,152,000 (320×240×15) [pixels/s]

In this case, the processing speed necessary for time-division coding processing of the moving image signals SS0 to SS2b is 36,864,000+9,216,000+4,608,000+2,304,000+1,152,000=54,144,000 [pixels/s], and exceeds the maximum processing speed (49,152,000 [pixels/s]).

### [Step ST103]

Then, normal coding processing is carried out. In this case, the moving image signals SS0 to SS2b are coded in a time-division manner on a picture-by-picture basis, thereby generating coded streams STR0 to STR2b associated with the moving image signals SS0 to SS2b. Specifically, the control section 101 allocates one channel to each of the moving image signals SS0 to SS2b, and sets the stream generating section 104 and the reconstruction section 105 at the normal mode. Then, the control section 101 specifies the moving image signals SS0 to SS2b one by one. The input section 102 supplies a picture of a moving image signal specified by the control section 101 to the coding section 103. The coding section 103 codes the picture from the input section 102. The stream generating section 104 outputs the coded picture generated by the coding section 103 as a coded stream associated with the moving image signal specified by the control section 101. The reconstruction section 105 reconstructs an original picture (i.e., a picture before coding) from the coded picture, and writes the reconstructed picture in the memory section 106 as a reference picture associated with the moving image signal specified by the control section 101. The memory section 106 stores five reference pictures associated with the five moving image signals SS0 to SS2b.

### [Step ST104]

On the other hand, when it is determined at step ST102 that the coding settings exceed the maximum processing performance, the control section 101 refers to the coding settings and determines whether or not a plurality of moving image signals with an identical resolution and different frame rates have been set at step ST101. If such moving image signals have been set, the process proceeds to step ST105. Otherwise, the process proceeds to step ST101 and the coding settings are corrected not to exceed the maximum processing performance of the moving image coding apparatus 1.

### [Step ST105]

Subsequently, the control section 101 refers to the coding settings and divides the moving image signals set at step ST101 into groups corresponding to the respective resolutions. Then, the control section 101 selects a moving image signal with the highest frame rate from each of the groups. Specifically, in the case of the foregoing example of coding settings, the moving image signals are divided into three groups: a group 1 to which only the moving image signal SS0 belongs; a group 2 to which the moving image signals SS1a and SS1b belong; and a group 3 to which the moving image signals SS2a and SS2b belong. Then, the moving image signal SS0 is selected from the group 1, the moving image signal SS1a is selected from the group 2, and the moving image signal SS2a is selected from the group 3.

### [Step ST106]

Then, the control section 101 determines whether or not the coding of the moving image signals selected from the groups exceeds the maximum processing performance of the moving image coding apparatus 1. If the coding settings do not exceed the maximum processing performance, the process proceeds to step ST107. Otherwise, the process proceeds to step ST101. Specifically, the control section 101 determines whether or not the number of the selected moving image signals exceed the maximum channel number of the moving image coding apparatus 1 and also determines whether or not the processing speed necessary for coding the selected moving image signals in a time-division manner exceeds the maximum processing speed of the moving image coding apparatus 1. If the coding settings of the selected moving image signals exceed at least one of the maximum channel number and the maximum processing speed, the process proceeds to step ST101, and the coding settings are corrected.

For example, in the case of the above example of coding settings, the number of the selected moving image signals is “3”, i.e., does not exceed the maximum channel number of “5”.

On the other hand, in the above example of coding settings, the processing speeds necessary for the respective selected moving image signals SS0, SS1a and SS2a are:

Moving image signal SS0: 36,864,000 (1,280×960×30) [pixels/s]

Moving image signal SS1a: 9,216,000 (640×480×30) [pixels/s]

Moving image signal SS2a: 2,304,000 (320×240×30) [pixels/s]

In this case, the processing speed necessary for time-division coding of the moving image signals SS0, SS1a and SS2a is 36,864,000+9,216,000+2,304,000=48,384,000 [pixels/s] and does not exceed the maximum processing speed (49,152,000 [pixels/s]).

### [Step ST107]

Thereafter, multi-stream generation processing is performed. In this case, only moving image signals (which are the moving image signals SS0, SS1a and SS1b in the above example) selected from the moving image signals SS0 to SS2b at step ST105 are coded in a time-division manner. For a moving image signal (e.g., the moving image signal SS1b) which is not coded out of the moving image signals SS0 to SS2b, based on the frame rate of this uncoded moving image signal, one or more coded pictures are eliminated from the coded stream associated with a moving image signal (e.g., the moving image signal SS1a) with the same resolution as the uncoded moving image signal, thereby generating a coded stream associated with the uncoded moving image signal.

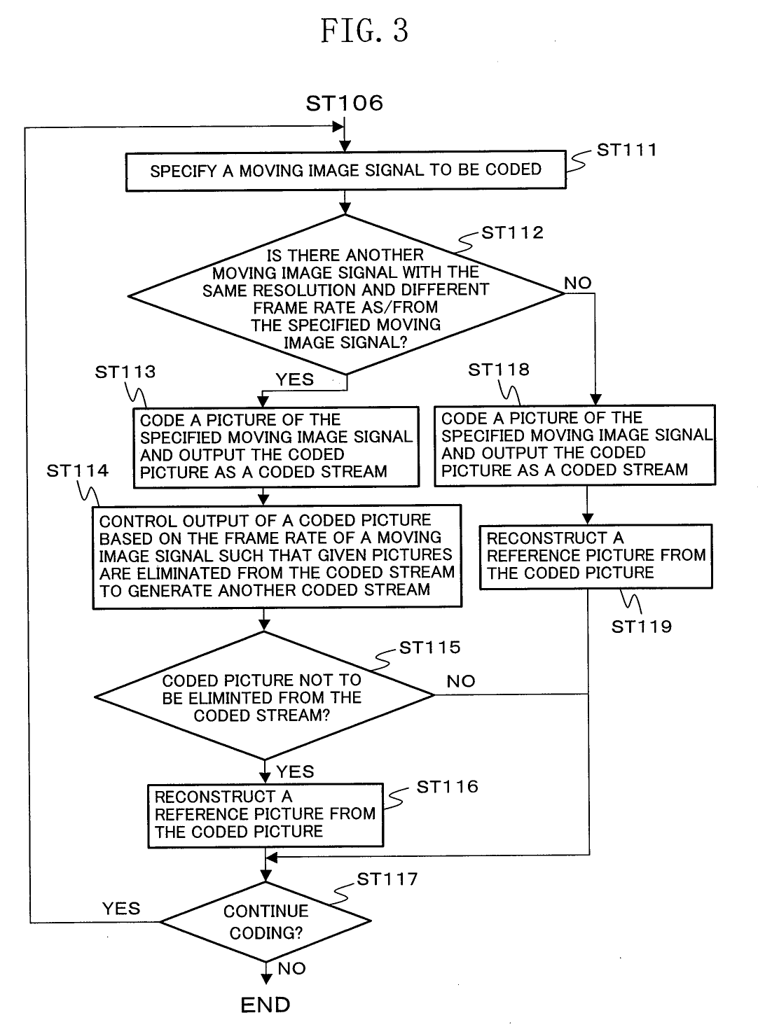

Now, multi-stream generation processing shown in FIG. 2 is described with reference of FIG. 3. In the following description, the foregoing coding settings are used as an example. In this case, the control section 101 allocates one channel to each of the three moving image signals SS0, SS1a and SS2a. The memory section 106 stores three reference pictures associated with the three moving image signals SS0, SS1a and SS2a.

### [Step ST111]

First, the control section 101 selects one of the three channels allocated to the respective moving image signals SS0, SS1a and SS2a selected at step ST105. Then, one of the moving image signals SS0, SS1a and SS2a selected at step ST105 is specified as a moving image signal to be coded.

### [Step ST112]

Next, the control section 101 searches for a moving image signal whose resolution is the same as, and frame rate is different from, the moving image signal specified at step ST111 in the moving image signals SS0 to SS2b as a target of coding, with reference to the coding settings. If such a moving image signal is detected, the process proceeds to step ST113. Otherwise, the process proceeds to step ST118. Specifically, if the moving image signal SS1a is specified at step ST111, the control section 101 detects the moving image signal SS1b belonging to the same group as the moving image signal SS1a.

### [Step ST113]

Then, the control section 101 sets the stream generating section 104 and the reconstruction section 105 at the multi-stream generation mode. Thereafter, the input section 102 supplies a picture of the moving image signal specified at step ST111 to the coding section 103. The coding section 103 codes the picture from the input section 102. The picture coded by the coding section 103 is output from the stream generating section 104 as a coded stream associated with the moving image signal specified at step ST 11.

### [Step ST114]

Based on the frame rate of the moving image signal (e.g., the moving image signal SS1b) detected at step ST112, in order to generate a coded stream (a coded stream STR1b) associated with this moving image signal, the control section 101 specifies a coded picture to be eliminated from the coded steam (a coded stream STR1a) associated with the moving image signal specified at step ST111. If the coded picture obtained at step ST113 is not a “coded picture to be eliminated specified by the control section 101” (i.e., is a “coded picture not to be eliminated”), the stream generating section 104 outputs the coded picture as a coded stream (a coded stream STR1b) associated with the moving image signal detected at step ST112. On the other hand, if the coded picture obtained at step ST113 is a “coded picture to be eliminated specified by the control section 101” (i.e., is a “coded picture to be eliminated”), the stream generating section 104 does not output the coded picture. In this manner, the output of the coded picture is controlled based on the frame rate of the moving image signal detected at step ST112. If a plurality of moving image signals are detected at step ST112, the foregoing processing is performed on each of the detected moving image signals.

[Step ST115]

Thereafter, the reconstruction section 105 determines whether or not the coded picture obtained at step ST113 is a coded picture not to be eliminated from the coded stream at step ST114. If this coded picture is a coded picture not to be eliminated, the process proceeds to step ST116. Otherwise, the process proceeds to step ST117.

### [Step ST116]

Subsequently, the reconstruction section 105 reconstructs an original picture (i.e., a picture before coding) from the coded picture obtained at step ST113, and writes the reconstructed picture in the memory section 106 as a reference picture associated with the moving image signal specified at step ST111.

### [Step ST117]

Then, if coding processing is to be continued, the process proceeds to step ST111 and the control section 101 selects the next channel.

### [Step ST118]

On the other hand, if no other moving image signal is detected at step ST112 (e.g., the moving image signal SS0 is specified at step ST111), the control section 101 sets the stream generating section 104 and the reconstruction section 105 at the normal mode. Then, processing similar to that in step ST113 is carried out so that a picture of the moving image signal specified at step ST111 is coded and the resultant coded picture is output as a coded stream (STR0) associated with this moving image signal.

### [Step ST119]

Then, processing similar to that in step ST114 is carried out so that the reconstruction section 105 reconstructs an original picture from the coded picture. The reconstructed picture is written in the memory section 106 as a reference picture associated with the moving image signal specified at step ST111. Then, the process proceeds to step ST117.

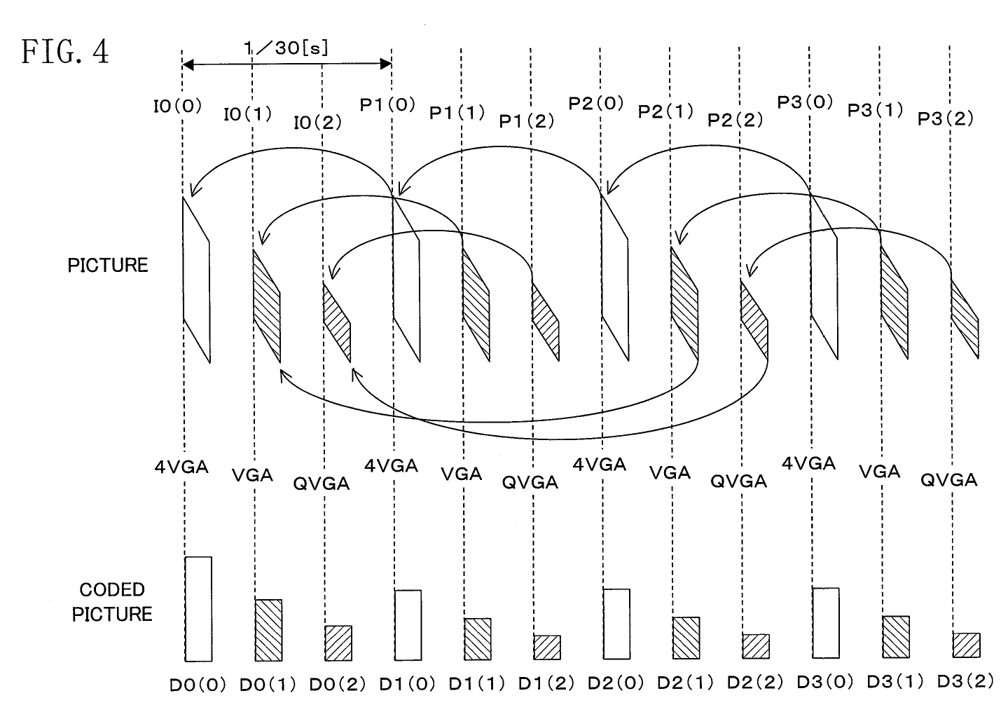

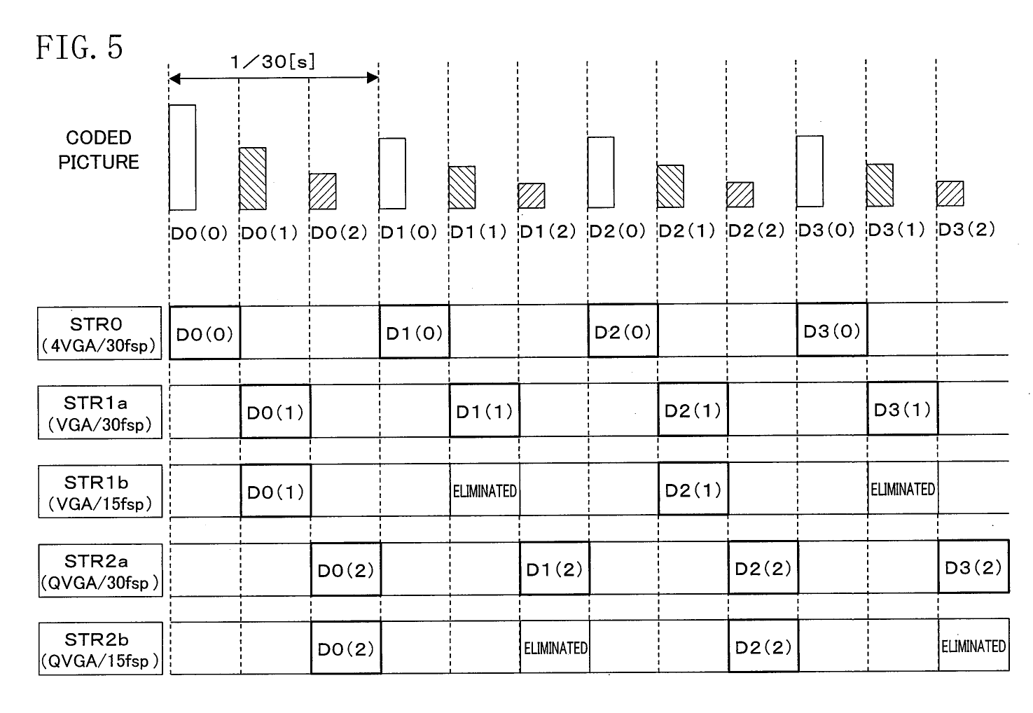

Now, coding processing in the moving image coding apparatus 1 is specifically described with reference to FIGS. 4 and 5. In the following description, pictures I0(0), P1(0), P2(0), P3(0), . . . are included in the moving image signal SS0, pictures I0(1), P1(1), P2(1), P3(1), . . . are included in the moving image signal SS1a, and pictures I0(2), P1(2), and P2(2), P3(2), . . . are included in the moving image signal SS2a.

The frame rate of the moving image signal SS1b is “½” of the frame rate of the moving image signal SS1a. In other words, the moving image signal SS1b is a moving image signal obtained by eliminating every other coded picture from the moving image signal SS1a. Thus, coded pictures D1(1) and D3(1) associated with the pictures P1(1) and P3(1) are “coded pictures to be eliminated”. In the same manner, since the moving image signal SS2b is a moving image signal obtained by eliminating every other coded picture from the moving image signal SS2a, coded pictures D1(2) and D3(2) associated with the pictures P1(2) and P3(2) are “coded pictures to be eliminated”.

### [Pictures I0(0), I0(1) and I0(2)]

First, the coding section 103 sequentially performs intra-coding on the first pictures I0(0), I0(1) and I0(2) of the respective three moving image signals SS0, SS1a and SS2a for a given time (which is herein 1/30 [s]), thereby generating coded pictures D0(0), D0(1) and D0(2). The reconstruction section 105 reconstructs pictures I0(0), I0(1) and I0(2) from the coded pictures D0(0), D0(1) and D0(2) and stores these reconstructed pictures in the memory section 106 as reference pictures associated with the moving image signals SS0, SS1a and SS2a.

The stream generating section 104 outputs the coded picture D0(0) as a coded stream STR0. The stream generating section 104 also outputs the coded picture D0(1) as a coded stream STR1a and also as a coded stream STR1b. In the same manner, the stream generating section 104 outputs the coded picture D0(2) as a coded stream STR2a and also as a coded stream STR2b.

### [Pictures P1(0), P1(1) and P1(2)]

Next, the coding section 103 performs inter-coding on the pictures P1(0), P1(1) and P1(2) in a time-division manner, thereby generating coded pictures D1(0), D1(1) and D1(2). The reconstruction section 105 reconstructs the picture P1(0) from the coded picture D1(0) and the reference picture I0(0), and rewrites a reference picture associated with the moving image signal SS0 as a “picture P1(0). On the other hand, since the coded picture D1(1) is a “coded picture to be eliminated”, the reconstruction section 105 does not reconstruct the picture P1(1). Accordingly, the reference picture associated with the moving image signal SS1a remains as the “picture I0(1)”. In the same manner, since the coded picture D1(2) is a “coded picture to be eliminated”, the reconstruction section 105 does not reconstruct the picture P1(2). Thus, the reference picture associated with the moving image signal SS2a remains as the “picture I0(2)”.

The stream generating section 104 outputs the coded pictures D1(0), D1(1) and D1(2) as coded streams STR0, STR1a and STR2a. On the other hand, since the coded picture D1(1) s a “coded picture to be eliminated”, the stream generating section 104 does not output the coded picture D1(1) as a coded stream STR1b. In the same manner, since the coded picture D1(2) is a “coded picture to be eliminated”, the stream generating section 104 does not output the coded picture D1(2) as a coded steam STR2b.

### [Pictures P2(0), P2(1) and P2(2)]

Thereafter, the pictures P2(0), P2(1) and P2(2) are subjected to inter-coding in a time-division manner, thereby generating coded pictures D2(0), D2(1) and D2(2). The picture P2(0) is subjected to inter-coding using the immediately-preceding picture P1(0) as a reference picture, whereas the pictures P2(1) and P2(2) are subjected to inter-coding using second immediately preceding pictures I0(1) and I0(2) as reference pictures. Since the coded pictures D2(0), D2(1) and D2(2) are “pictures not to be eliminated”, the pictures P2(0), P2(1) and P2(2) are reconstructed from the coded pictures D2(0), D2(1) and D2(2) and the reference pictures P1(0), I0(1) and I0(2).

The stream generating section 104 outputs the coded picture D2(0) as a coded stream STR0, outputs the coded picture D2(1) as coded streams STR1a and STR1b, and outputs the coded picture D2(2) as coded streams STR2a and STR2b.

As described above, a plurality of coded streams associated with a plurality of moving image signals are generated from one moving image signal without individually coding the moving image signals. This enables increase in the number of coded streams without enhancing processing performance of the moving image coding apparatus and without parallel processing of a plurality of sets of moving image coding apparatus. Accordingly, even when the number of moving image signals as a target of coding increases, reduction in size and power consumption of the moving image coding apparatus is achieved.

No reconstruction is performed on reference pictures associated with coded pictures to be eliminated. Thus, the number of reconstructions of reference pictures decreases accordingly. This reduces the number of rewriting accesses to the memory section 106 for storing reference pictures, for example, thus reducing cost and power consumption in the system level without the necessity for enhancing access performance of the memory section 106.

The number of moving image signals as a target of coding and the resolutions and frame rates of the moving image signals are, of course, not limited to the foregoing description.

### (Modified Example of Multi-Stream Generation Processing)

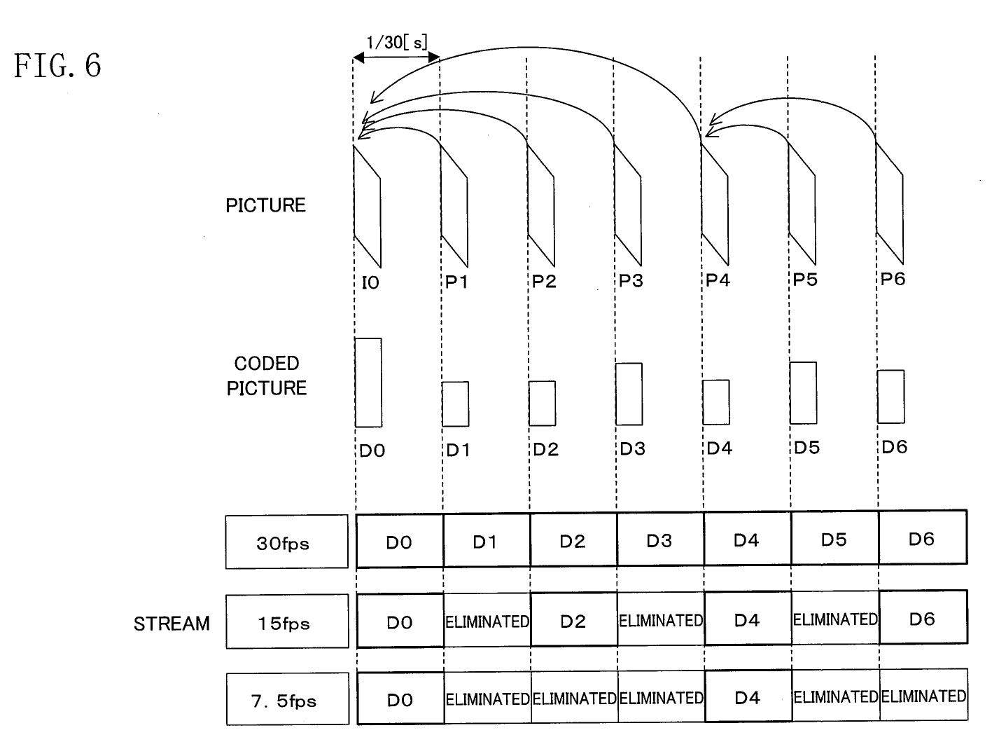

As shown in FIG. 6, it is possible to generate three or more coded streams from one moving image signal. Specifically, three moving image signals with an identical resolution and with frame rates of “30 fps”, “15 fps” and “7.5 fps”, respectively, are allowed to be coded. The moving image signal with a frame rate of “15 fps” corresponds to a signal obtained by eliminating every other picture from the moving image signal with a frame rate of “30 fps”. The moving image signal with a frame rate of “7.5 fps” corresponds to a signal obtained by eliminating three pictures at every time from the moving image signal with a frame rate of “30 fps”.

In this case, the coding section 103 codes pictures 10, P1, P2, P3, . . . and P6 included in the moving image signal with a frame rate of “30 fps”, thereby generating coded pictures D0, D1, D2, D3, . . . and D6. The stream generating section 104 outputs the coded pictures D0, D1, D2, D3, . . . and D6 as a coded stream associated with the moving image signal with a frame rate of “30 fps”.

The stream generating section 104 outputs the coded pictures D0, D2, D4 and D6 as a coded stream associated with the moving image signal with a frame rate of “15 fps”. On the other hand, the coded pictures D1, D3 and D5 are not output as a coded stream associated with the moving image signal with a frame rate of “15 fps” because the coded pictures D1, D3 and D5 are “pictures to be eliminated” in order to generate a coded stream associated with the moving image signal with a frame rate of “15 fps”.

Further, the stream generating section 104 outputs the coded pictures D0 and D4 as a coded stream associated with the moving image signal with a frame rate of “7.5 fps”. On the other hand, the coded pictures D1, D2, D3, D5 and D6 are not output as a coded stream associated with the moving image signal with a frame rate of “7.5 fps” because the coded pictures D1, D2, D3, D5 and D6 are “pictures to be eliminated” in order to generate a coded stream associated with the moving image signal with a frame rate of “7.5 fps”.

In this manner, three coded streams are generated only by coding the moving image signal with a frame rate of “30 fps”.

### Modified Example 1 of Embodiment 1

During inter-coding by the coding section 103, the time difference between a picture as a target of coding and a reference picture increases, the correlation between these pictures becomes lower so that the difference between the picture as a target of coding and the reference picture is likely to increase. In particular, when a picture as a target of coding exhibits a fast motion, the correlation between the pictures greatly decreases. For example, when the picture P1(1) and the picture P2(1) in FIG. 4 are compared with each other, the coding efficiency in inter-coding of the picture P2(1) is more likely to decrease than that in inter-coding of the picture P1(1).

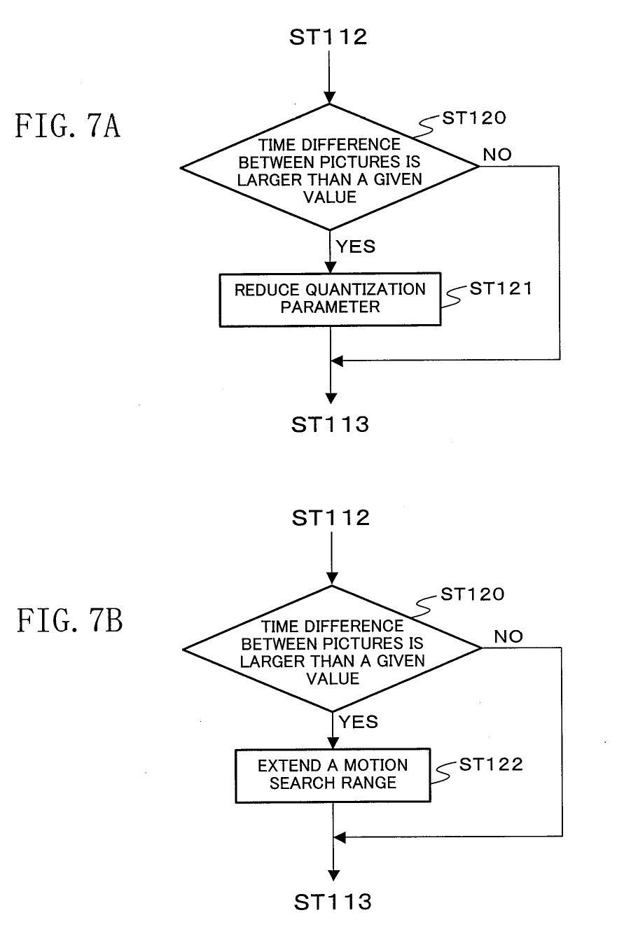

In view of this, as shown in FIG. 7A, the value of a quantization parameter used for coding of pictures may be adjusted based on the time difference between a picture as a target of coding and a reference picture. Specifically, the control section 101 determines whether or not the time difference between a picture supplied from the input section 102 to the coding section 103 and a reference picture associated with this picture is larger than a given value (step ST120). If it is determined that the time difference is larger than the given value, the control section 101 reduces the quantization parameter set in the coding section 103 (step ST121).

This control suppresses deterioration of the image quality. To set the quantization parameter at a low value, the quantization parameter before the adjustment may be multiplied by a variable a (where 0<α<1) or a fixed value β (where β is a natural number) may be subtracted from the quantization parameter before the adjustment.

### Modified Example 2 of Embodiment 1

As shown in FIG. 7B, a motion search range used for inter-coding of pictures may be adjusted based on the time difference between a picture as a target of coding and a reference picture. Specifically, the control section 101 determines whether or not the time difference between a picture supplied from the input section 102 to the coding section 103 and a reference picture associated with this picture is larger than a given value (step ST120). If it is determined that the time difference is larger than the given value, the control section 101 extends a motion search range set in the coding section 103 (step ST122). For example, if the motion search range before the adjustment is −32 to +32 in the horizontal and vertical directions, the motion search range is extended to −64 to +64 in the horizontal and vertical directions.

With this control, a position exhibiting a high correlation between pictures is more easily detected from pictures as a target of coding, thus suppressing deterioration of the image quality.

### Embodiment 2

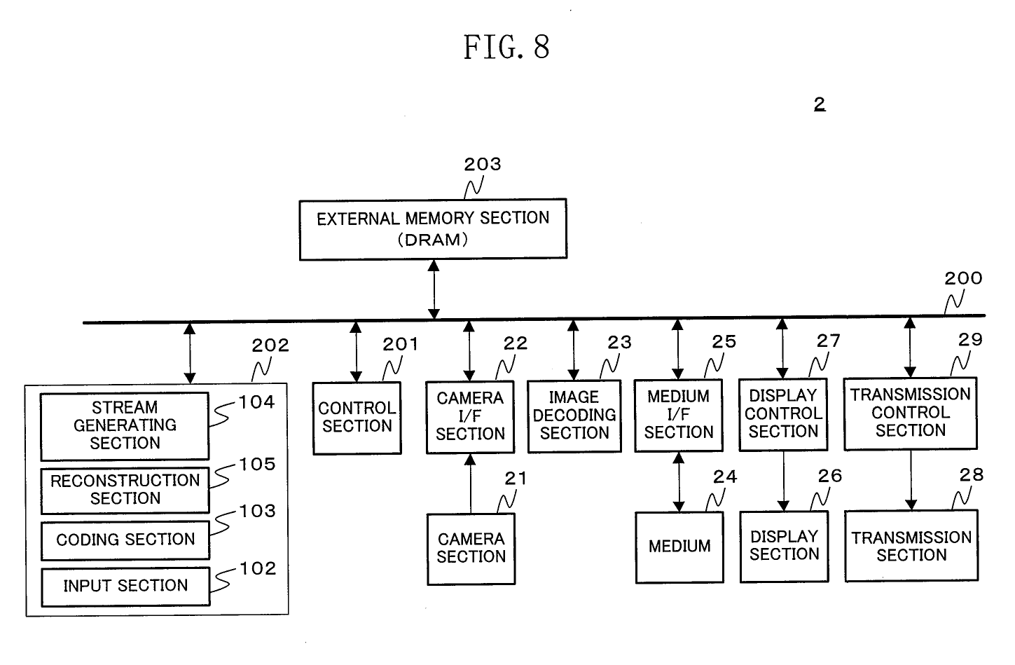

FIG. 8 illustrates a configuration of an imaging system according to a second embodiment of the present invention. The imaging system 2 includes: a moving image coding section 202 for performing moving image coding processing; a camera section 21; a camera I/F section 22; an image decoding section 23; a medium 24; an medium I/F section 25; a display section 26; a display control section 27; a transmission section 28; a transmission control section 29; a control section 201 for controlling the foregoing components; an external memory section 203 shared by the foregoing components; and a memory bus 200 connecting the foregoing components to the external memory section 203.

The moving image coding section 202 includes: an input section 102; a coding section 103; a stream generating section 104; and a reconstruction section 105, which are shown in FIG. 1. The control section 201 performs processing similar to that of the control section 101 shown in FIG. 1, in addition to control of blocks constituting the imaging system 2. A region for storing a reference picture used for moving image coding processing is allocated to a part of the external memory section 203.

The external memory section 203 is accessed not only by the moving image coding section 202 but also by the control section 201, the camera I/F section 22, the image decoding section 23, the medium I/F section 25, the display control section 27 and the transmission control section 29. In particular, an imaging device such as a CCD or CMOS sensor is incorporated in the camera section 21 connected to the camera I/F section 22. The number of pixels of this imaging device varies depending on the type of an imaging system (e.g., a popular type or an expensive type). Therefore, the amount of access from the camera I/F section 22 to the external memory section 203 varies depending on specifications of the camera section 21. As the display section 26 connected to the display control section 27, a liquid-crystal monitor with a QVGA resolution is used in some cases or a plasma display with an HDTV resolution is used in other cases. Accordingly, the amount of access from the display control section 27 to the external memory section 203 varies depending on specifications of the display section 26. In this manner, the amount of access to the external memory section 203 is not always constant and varies depending on specifications of components included in the imaging system.

The moving image coding section 202 shown in FIG. 8 is switched between normal coding processing and multi-stream generation processing based on the traffic amount (i.e., the total amount of data transmitted to and from the external memory section 203 for a given time) of the memory bus 200.

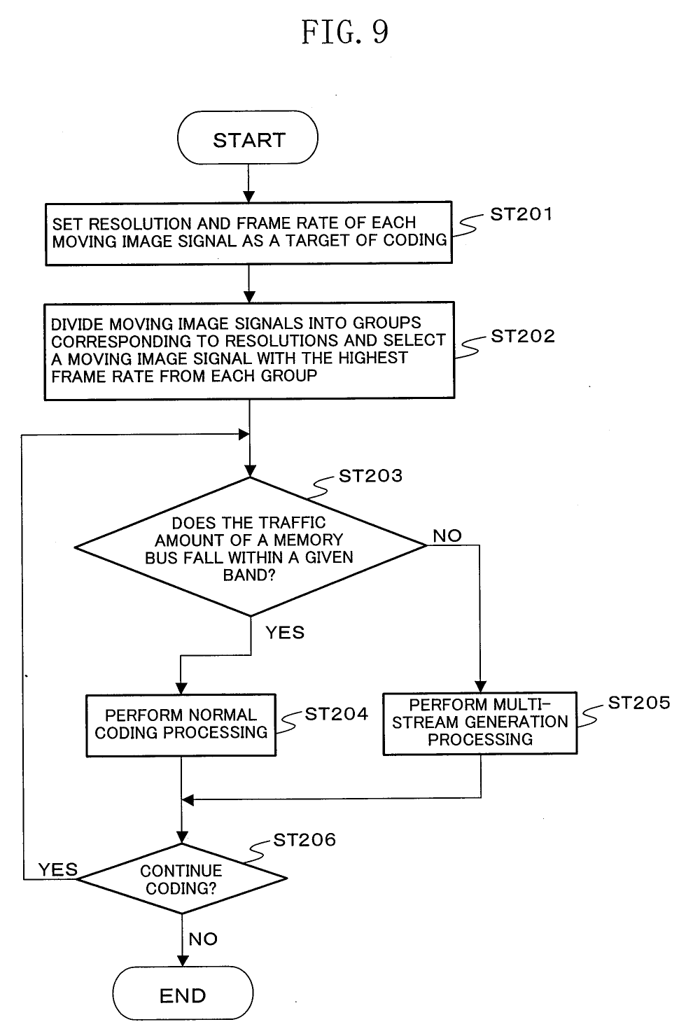

Now, moving image coding processing by the imaging system shown in FIG. 8 is described with reference to FIG. 9.

First, as in step ST101, the resolution and the frame rate of each moving image signal as a target of coding are set and information on the coding settings is supplied to the control section 201 (step ST201). Next, as in step ST105, the control section 201 divides a plurality of moving image signals whose resolutions and frame rates have been set at step ST201 into groups corresponding to respective resolutions with reference to the coding settings, and selects a moving image signal with the highest frame rate from each of the groups (step ST202). Thereafter, the control section 201 determines whether or not the traffic amount of the memory bus 200 falls within a given band (step ST203). If the traffic amount falls within the given band, processing similar to that in step ST103 (i.e., normal coding processing) is performed (step ST204). Otherwise, processing similar to that in step ST107 (i.e., multi-stream generation processing) is performed (step ST205). Then, if coding is to be continued, the foregoing processing is carried out again (step ST206).

As described above, if the memory bus 200 has a large traffic amount, the multi-stream generation processing is performed to decrease the number of writing of reference pictures from the moving image coding section 202 (the reconstruction section 105) in the external memory section 203. Accordingly, access from blocks except for the moving image coding section 202 to the external memory section 203 is less interfered, thus implementing moving image coding processing optimum for the imaging system.

The processing described in each of the first and second modified examples of the first embodiment is, of course, applicable to the processing described in the second embodiment.

### Embodiment 3

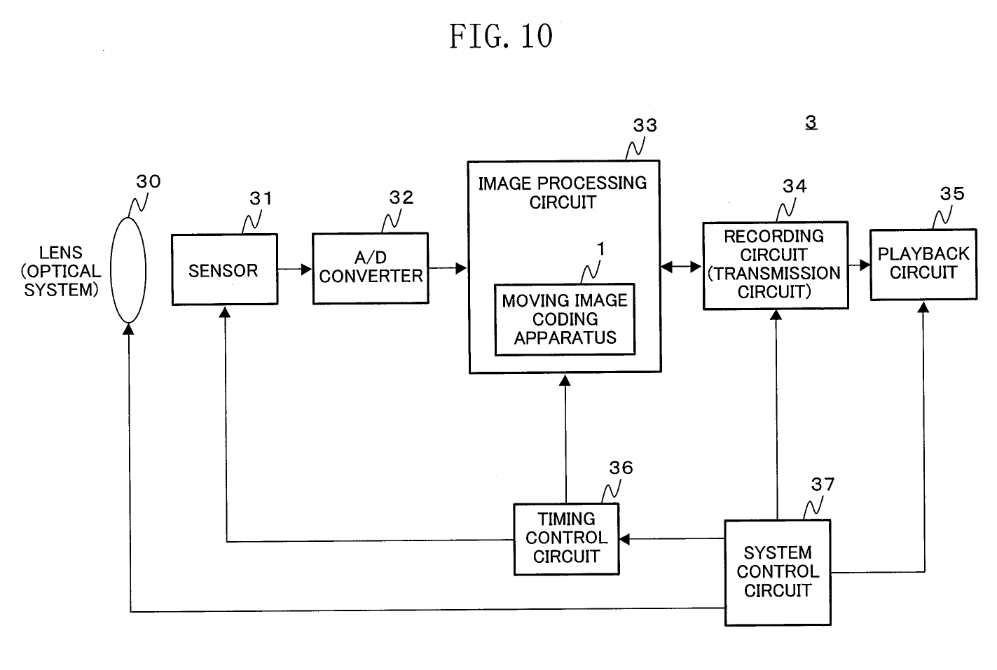

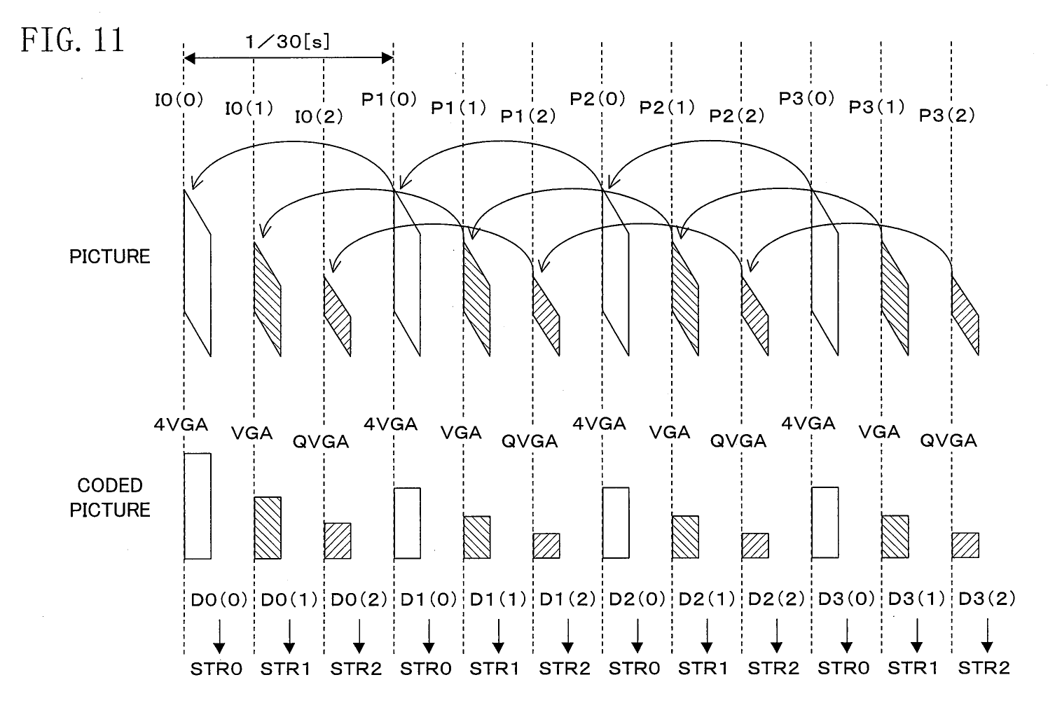

As illustrated in FIG. 10, the moving image coding apparatus 1 shown in FIG. 1 may be installed in an imaging system such as a digital still camera or a network camera. In FIG. 10, an imaging system 3 includes: an image processing circuit 33 including the moving image coding apparatus 1; a lens (i.e., an optical system) 30; an analog-to-digital (A/D) converter 32; a recording circuit 34; a playback circuit 35; a timing control circuit 36; and a system control circuit 37.

In the imaging system 3, image light incident through the lens (i.e., the optical system) 30 is formed into an image on a sensor 31 and is subjected to photoelectric conversion. An electric signal obtained through photoelectric conversion is converted into a digital signal by the A/D converter 32 and is then supplied to an image processing circuit 33. The image processing circuit 33 performs a Y/C process, an edge treatment, extension/contraction of images, compression/expansion of images such as JPEG and MPEG, and control of streams subjected to image compression, for example. A signal processed by the image processing circuit 33 is recorded in the recording circuit 34. The signal recorded in the recording circuit 34 is played back by the playback circuit 35. The timing control circuit 36 controls the sensor 31 and the moving image coding apparatus 1 included in the image processing circuit 33. The system control circuit 37 controls the lens 30, the recording circuit 34, the playback circuit 35 and the timing control circuit 36.

The recording circuit 34 may be replaced by a transmission circuit for transmitting a signal processed by the image processing circuit 33 via, for example, the Internet. In this case, the playback circuit 35 plays back a signal transmitted by the transmission circuit.

In the imaging system shown in FIG. 10, the imaging system such as camera equipment for performing photoelectric conversion on image light from the lens 30 and then inputting the converted signal to the A/D converter 32 is described. However, the present invention is limited to the foregoing description and other analog video inputs from AV equipment such as a TV set may be directly connected to the A/D converter 32.

The present invention is useful not only for digital still cameras required to perform coding with low power consumption but also for monitoring cameras and network cameras, for example.

What is claimed is:

1. A method for coding a moving image signal including a plurality of pictures arranged in chronological order, the method comprising the steps of:
(a) coding the moving image signal into a coded stream; and
(b) periodically eliminating at least one coded picture from the moving image signal coded at step (a), thereby generating another coded stream associated with another moving image signal having a frame rate different from that of the coded moving image signal.

2. The method of claim 1, wherein in step (a), a first moving image signal having a highest frame rate among m (where m is an integer of at least two) moving image signals having an identical resolution and different frame rates is coded into a first coded stream associated with the first moving image signal, and
in step (b), at least one coded picture is eliminated from the first moving image signal coded at step (a) based on the frame rates of (m−1) second moving image signals obtained by removing the first moving image signal from the m moving image signals, thereby generating (m−1) second coded streams associated with the (m−1) second moving image signals.

3. The method of claim 2, further comprising the steps of:
(c1) determining whether or not the number m of moving image signals as a target of coding exceeds a predetermined maximum number of moving image signals; and
(d) coding the m moving image signals in a time-division manner into m coded moving image signals as m coded streams when it is determined at step (c1) that the number m of the moving image signals does not exceed the maximum number,
wherein steps (a) and (b) are performed when it is determined at step (c1) that the number m of the moving image signals exceeds the maximum number.

4. The method of claim 2, further comprising the steps of:
(c2) determining whether or not a necessary processing speed necessary for coding the m moving image signals in a time-division manner exceeds a predetermined maximum processing speed; and
(d) coding the m moving image signals in a time-division manner into m coded moving image signals as m coded streams when it is determined at step (c2) that the necessary processing speed does not exceed the maximum processing speed,
wherein steps (a) and (b) are performed when it is determined at step (c2) that the necessary processing speed exceeds the maximum processing speed.

5. The method of claim 2, further comprising the step of (a1) reconstructing a reference picture only from a coded picture which is not eliminated at step (b) out of a plurality of coded pictures included in the first moving image signal coded at step (a),
wherein at step (a), a picture of the first moving image signal is subjected to inter-coding using the reference picture.

6. The method of claim 5, wherein in step (a), a quantization parameter is adjusted based on a time difference between a picture of the first moving image signal and a reference picture associated with the picture of the first moving image signal, and then the picture of the first moving image signal is subjected to inter-coding.

7. The method of claim 5, wherein in step (a), a motion search range is adjusted based on a time difference between a picture of the first moving image signal and a reference picture associated with the picture of the first moving image signal, and then the picture of the first moving image signal is subjected to inter-coding.

8. The method of claim 5, further comprising the steps of:
(e) determining whether or not the total amount of data transmitted to and from a memory medium for a given time falls within a given band; and
(f) coding the m moving image signals in a time-division manner into m coded moving image signals as m coded streams when it is determined at step (e) that the total amount of data falls within the given band,
wherein the memory medium stores the reference picture, and
steps (a), (b) and (a1) are performed when it is determined at step (e) that the total amount of data does not fall within the given band.

9. A moving image coding apparatus for coding a moving image signal including a plurality of pictures arranged in chronological order, the apparatus comprising:
a coding section for coding the moving image signal into a coded stream; and
a stream generating section for periodically eliminating at least one coded picture from the moving image signal coded by the coding section, thereby generating another coded stream associated with another moving image signal having a frame rate different from that of the coded moving image signal.

10. The moving image coding apparatus of claim 9, wherein the coding section codes a first moving image signal having a highest frame rate among m (where m is an integer of at least two) moving image signals having an identical resolution and different frame rates, thereby generating a first coded stream associated with the first moving image signal, and
the stream generating section eliminates at least one coded picture from the first moving image signal coded by the coding section, based on the frame rates of (m−1) second moving image signals obtained by removing the first moving image signal from the m moving image signals, thereby generating (m−1) second coded streams associated with the (m−1) second moving image signals.

11. The moving image coding apparatus of claim 10, further comprising a control section for determining whether or not the number m of moving image signals as a target of coding exceeds a predetermined maximum number of moving image signals,
wherein the coding section codes the m moving image signals in a time-division manner into m coded streams associated with the m moving image signals when the control section determines that the number m of the moving image signals does not exceed the maximum number, whereas the coding section codes the first moving image signal out of the m moving image signals into the first coded stream when the control section determines that the number m of the moving image signals exceeds the maximum number, and
when the control section determines that the number m of the moving image signals exceeds the maximum number, the stream generating section eliminates at least one of the coded pictures from the first moving image signal coded by the coding section, thereby generating the (m−1) second coded streams.

12. The moving image coding apparatus of claim 10, further comprising a control section for determining whether or not a necessary processing speed necessary for coding the m moving image signals in a time-division manner exceeds a predetermined maximum processing speed,
wherein the coding section codes the m moving image signals in a time-division manner into m coded streams associated with the m moving image signals when the control section determines that the necessary processing speed does not exceed the maximum processing speed, whereas the coding section codes the first moving image signal out of the m moving image signals into the first coded stream when the control section determines that the necessary processing speed exceeds the maximum processing speed, and
when the control section determines that the necessary processing speed exceeds the maximum processing speed, the stream generating section eliminates at least one of the coded pictures from the first moving image signal coded by the coding section, thereby generating the (m−1) second coded streams.

13. An imaging system, comprising
an image processing circuit including a moving image coding apparatus of claim 9; and
an analog-to-digital converter for converting an externally-input electric signal into a digital signal and supplying the digital signal to the image processing circuit as the moving image signal.

14. The imaging system of claim 13, further comprising an imaging circuit for converting an image of an object into an electric signal,
wherein the analog-to-digital converter converts the electric signal obtained by the imaging circuit into the digital signal.
